(19) United States
(12) Patent Application Publication
(10) Pub. No.: US 2026/0034959 A1
(43) Pub. Date: Feb. 5, 2026

(54) Vehicle Power Security Apparatus and Method

(71) Applicant: Mercury R and D LLC, Coeur d'Alene, ID (US)

(72) Inventor: Michael T. Kralicek, Coeur d'Alene, ID (US)

(73) Assignee: Mercury R and D LLC, Coeur d'Alene, ID (US)

(21) Appl. No.: 18/791,346

(22) Filed: Jul. 31, 2024

(51) Int. Cl. B60R 25/01; B60R 16/033; B60R 25/102; B60R 25/33

(52) U.S. Cl. CPC B60R 25/01; B60R 16/033; B60R 25/102; B60R 25/33

(57) ABSTRACT

A vehicle power security apparatus is provided having a power switch, a control system, and a security system. The power switch is configured to shut off one or more motive operating components of a vehicle. The security system has a mobile communication device with a unique indicia to identify the vehicle. The security system is provided in a concealed location to a third party user, signal coupled with the control system, and configured to communicate with a mobile device of a user to provide a unique identification of the vehicle to the mobile device; and receive a control command signal from the mobile device to activate the power switch and disable power to one or more motive vehicle components to disarm operation of the vehicle; and provide the unique indicia to the control system to trigger by triggering shutoff of the power switch. A method is also provided.

### TECHNICAL FIELD

The present disclosure generally relates to machine and vehicle security and anti-theft strategies. The present disclosure pertains to both machine and vehicle power and location security apparatus and methods.

### BACKGROUND OF THE INVENTION

The evolution of vehicle security has led to various implementations to include connectivity with vehicles and wireless security efforts to overtake and/or disarm an operating vehicle, typically implemented by the manufacturer. Efforts are further needed in order to provide techniques to prevent theft and/or identify location of a vehicle with an ability to disarm the vehicle that is not part of a manufacturer implementation where third parties have knowledge of how the vehicle security systems work and a user can self-implement a vehicle security strategy that will not be widely apparent by a potential thief having knowledge of factory security features.

### SUMMARY OF THE INVENTION

A vehicle security system and method is provided that enables an owner, or user to wirelessly disable power to motive components of a vehicle without general knowledge of a manufacturer, law enforcement, Federal Agency entities, and other individuals and organizations for which the user does not want knowledge of the security device to be known.

According to one aspect, a vehicle power security apparatus is provided having a power switch, a control system, and a security system. The power switch is configured to shut off one or more motive operating components of a vehicle. The control system has a processor communicating with the power switch and configured to: receive identification of a vehicle at risk of theft; generate a power switch shutoff command signal responsive to identification of and communication with the vehicle; and transmit the generated power switch shutoff command signal to the vehicle to disable operation of the vehicle. The security system has a mobile communication device with a unique indicia to identify the vehicle. The security system is provided in a concealed location to a third party user, signal coupled with the control system, and configured to: communicate with a mobile device of a user (trusted person) via a network using a communication channel and unique indicia to provide a unique identification of the vehicle to the mobile device; and receive a control command signal from the mobile device to activate the power switch and disable power to one or more motive vehicle components to disarm operation of the vehicle; and provide the unique indicia to the control system to trigger shutoff of the power switch

According to another aspect, a method is provided of remotely securing a vehicle against theft. The method includes: providing a power switch and a control system with a processor, and a vehicle security system having a mobile communication device with a unique indicia to identify the vehicle, the security system provided in a concealed location to a third party user, signal coupled with the control system; determining an identified vehicle having a risk of theft; generating a power switch shutoff command signal responsive to identification of and communication with the vehicle; transmitting the generated power switch shutoff command signal to the vehicle to disable operation of the vehicle; communicating with a mobile device of a user (trusted person) via a network using a communication channel and unique indicia to provide a unique identification of the vehicle to the mobile device; receiving a control command signal from the mobile device to activate the power switch and disable power to one or more motive vehicle components to disarm operation of the vehicle; and providing the unique indicia to the control system to trigger shutoff of the power switch.

### BRIEF DESCRIPTION OF THE DRAWINGS

FIG. 1 graphically illustrates a block diagram of a vehicle power security device that can be implemented on a vehicle according to an exemplary embodiment of the present disclosure.

FIG. 2 is a flowchart of exemplary operational steps of the processor to disable power to motive components of a vehicle.

FIG. 3 graphically illustrates an alternative block diagram of a machine power security device that can be implemented on a machine according to another exemplary embodiment of the present disclosure

### DETAILED DESCRIPTION OF THE ILLUSTRATED EMBODIMENTS

This disclosure of the invention is submitted in furtherance of the constitutional purposes of the U.S. Patent Laws “to promote the progress of science and useful arts” (Article 1, Section 8).

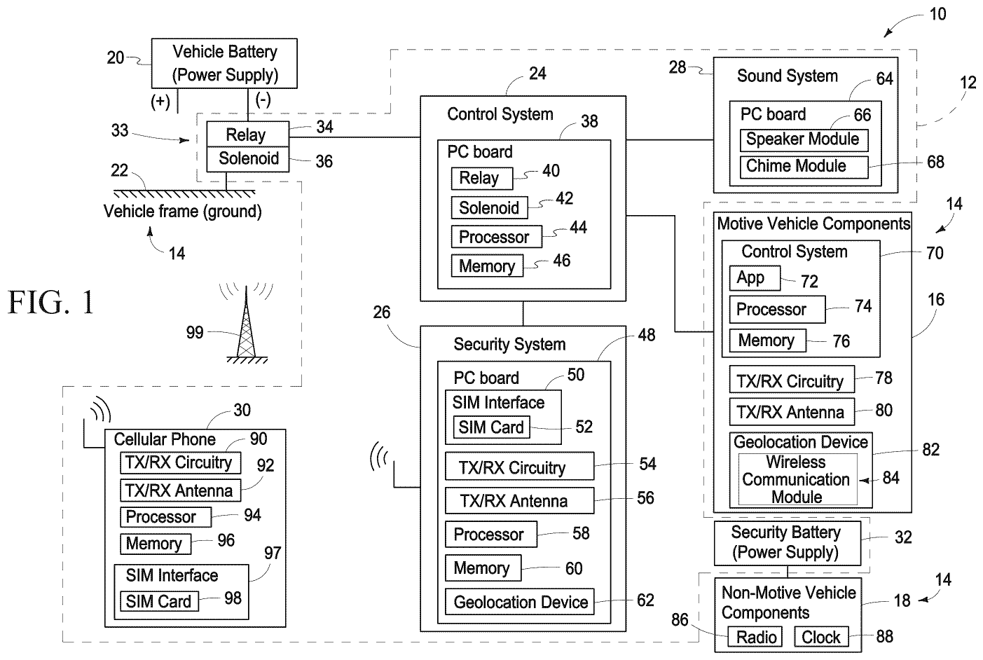

FIG. 1 graphically illustrates a block diagram of a vehicle power security device, or apparatus 12 that can be implemented on a vehicle 10 according to an exemplary embodiment of the present disclosure. More particularly, a motorized vehicle 10, such as a passenger automobile, having vehicle components 14 is shown having motive vehicle components 16, non-motive vehicle components 18, a vehicle battery, or power supply 20, a vehicle frame, or ground 22, and a vehicle power security apparatus 12.

As shown in FIG. 1, motive vehicle components 16 include components that contribute to operation of the vehicle as a mobile device, such as powertrain, steering, computer operation and control, wheels and suspension, electrical system components contributing to motive operation of the vehicle, such as, a control system 70, transmitting and receiving circuitry 78, a transmitting and receiving antenna 80, and a geolocation device 82. Control system 70 includes a control system computer application, a processor, or processing circuitry 74, and memory 76. Geolocation device 82 comprises a wireless communication module 84. Module 84 can comprise one or more of a Global System for Mobile Communications (GSM), a Global

Positioning System (GPS), or a satellite system, such as Russian GLONASS, European Galileo, Japanese QZSS and Chinese BeiDou Navigation Satellite System. One suitable commercially available open-source PC board system is a PC board for Arduino sold on Amazon.com as a SIM900 Quad-Band GPRS/GSM Shield Development Board for Arduino.

Additionally, FIG. 1 shows non-motive vehicle components 18 comprising a radio 86 and a clock 88. Clock 86 can be resident on radio 86 in some cases. Radio 86 can be provided in the form of a vehicle entertainment system that includes an internal clock and has memory for storing user data, such as device identification, time and calendar functions used by the entertainment system and/or vehicle.

Vehicle power security apparatus 12 of FIG. 1 comprises a control system 24, a security system 26, a sound system 28, a security battery 32, a power switch 33, and a cellular telephone 30. Control system 24 comprises a PC board 38 having a relay 40, a solenoid 42, a processor, or processing circuitry 44 and memory 46.

One optional addition that can be implemented on the security system of a vehicle is to provide a very loud/annoying or obnoxious siren that can be triggered by an owner on the vehicle before they terminate the main power supply to the vehicle, shutting down operation. This action will increase safety and may encourage a thief to pull over and exit the vehicle before motive vehicle components are shut down. This feature can have a verbal warning (stored in an audio file) that the vehicle is equipped with a security system and will be shutting off the car and the driver needs to pull over immediately for safety. The owner of the vehicle can shut down the vehicle without knowing where in traffic the thief actually is with the vehicle at the time the owner triggers the loud siren or obnoxious sound and verbal warning. Such an audio alert will encourage the thief to pull over and exit the vehicle and abandon the vehicle. The vehicle owner can shut down the operation of the vehicle, after a predetermined delay time, without worrying about traffic or vehicle collision concerns when they remove power to the operational components of the vehicle. A liability notice could be provided at sale time to the owner that installs the system in their car.

Security system 26 of vehicle power security apparatus 12 of FIG. 1 comprises a PC board 48 having a SIM interface 50 configured to removably receive a SIM card 52, transmitting/receiving circuitry 54, transmitting/receiving antenna 56, a processor, or processing circuitry 58, memory 60 and a geolocation device 62.

Sound system 28 of vehicle power security apparatus 12 of FIG. 1 comprises a PC board 64 having a speaker module 66 and a chime, or sound module 68.

Cellular telephone 30 of vehicle power security apparatus 12 of FIG. 1 comprises transmitting/receiving circuitry 90, transmitting/receiving antenna 92, processor, or processing circuitry 94, memory 96, a SIM interface 97, and a SIM card 98.

Power switch 33 of FIG. 1 comprises a relay 34 and a solenoid 36. In operation, relay 34 is signal activated from control system 24 to open and close another circuit that opens and closes solenoid 36. However, it is understood that any other kind of mechanical, electrical, electromechanical or electromagnetic switch can be used capable of opening and closing a ground (or optionally, a positive) lead to battery 20.

In operation, cellular phone 30 of FIG. 1 is configured to communicated via a cellular network over one or more antennas 99 with vehicle power security apparatus 12 to receive unique indicia, or identification of a vehicle and location, and send a power switch shutoff command to apparatus 12 to disable power to motive vehicle components 16 of vehicle components 14 of a vehicle 10 that has been stolen or is at risk of being stolen.

Vehicle battery, or first power supply 20 of FIG. 1 is a starter battery for a vehicle, such as a passenger car. Security battery, or second power supply 32 is a rechargeable battery that is trickled charged by vehicle battery 20 (trickle charger not shown) during normal vehicle operation and while parked/off. Security battery 32 is configured to only allow current to flow through a trickle charger at a reduced, or low current rating sufficient to charge security battery 32, but insufficient to operate motive components of the vehicle 10, such as a starter switch, starter motor, etc. A simple one-way trickle charge circuit, or battery maintainer, can be provided to charge the secondary power supply from the first power supply. In this way, second power supply 32 is isolated from first power supply 20. Optionally, an after-market DC power supply can be connected before the power switch 33.

Optionally, another switch (not shown) can be provided between the second power supply and the vehicle operating components configured to disconnect under a normal vehicle operating mode, but can be switched to connect with the secondary power supply (or battery) when the first power supply (battery) has fully discharged in order to enable starting of a vehicle in an emergency situation without rendering the security system ineffective. One such another switch comprises a physical battery switch that is hand activated by a user when the first power supply (battery) is fully discharged and/or dead.

In one case, the second power supply (battery) is completely electrically isolated from the first power supply (battery). However, there can also be provided a capability to utilize the second power supply in cases where the first power supply has failed, such as being fully drained. In such case, the vehicle owner, having knowledge of the security system installation, can manually reverse trickle charge direction (with a hidden switch) to change the secondary battery into trickle charge for the depleted or weakened primary battery function in order to start the vehicle. A simple mechanical switch placed within the vehicle, unfamiliar to a thief, would enable the user to also use the secondary battery to help charge the primary battery when the primary battery has been depleted, for example, where someone was cold left their car running at a rest stop to get some sleep with their headlights on, their vehicle battery died. The security, or second battery could be used and configured to give a small jumpstart or booster to the vehicle to start again in case the battery is too low to start.

In a first theft prevention scenario for the security system, a vehicle owner can prevent a carjacking, or hijacking of their vehicle from the owner while it is an operation mode. While the thief is trying to drive away, the owner, or user can remotely shut down power from the primary power supply using their cell phone and app. This scenario might include a case where the thief steals the vehicle with passengers inside, rendering them hostages. This security also can play a role in preventing the ability of thieves to clone fob keys (keyless remote entry transmitter). Cloning devices are available, some even on computer tablets and other devices, that enable thieves to clone a specific vehicle's fob key while is sitting by the vehicle owner's front door while the thief is standing on the front porch in close enough proximity to communicate with the fob key, enabling them to generate a clone fob key and then steal the car parked in the driveway. The present security system would prevent that from happening, thereby preventing thieves, including kids, from walking up onto the porch during the night while the owner is sleeping and cloning a new FOB key, stealing the car, all while the original FOB key is still in the home. By using the present features of the security system, an owner has an option to disable power to their vehicle from the primary power supply, thereby preventing such relatively easy fob key cloning.

In a second theft prevention scenario for the security system, a user can remotely disable power to their vehicle AFTER it has been valet parked, preventing any joy riding, abusive driving, or theft of the vehicle by the valet and without their knowledge that the security system even exists on the vehicle.

In a third theft prevention scenario for the security system, a user can remotely disable power to their vehicle while it is parked in an adjoining lot while they watch the game. The owner can feel secure knowing that their car cannot be started by a thief because the main power supply has been disconnected from the vehicle by the security system. An owner is a stadium watching a game can have peace of mind that their vehicle cannot be started by a thief.

In a fourth theft prevention scenario for the security system, the security system enables a vehicle user to remotely disconnect the primary power supply, or vehicle battery after they park in a long-term parking at an airport. In this mode, the vehicle will not be capable of being started by a thief and will be secure. When the owner returns from their trip, they can re-enable power from the battery to the vehicle.

Another additional security detail is provided in the manner in which the security system is made unobtrusive or hidden from a thief when installed on a vehicle. Components of the vehicle security system including the solenoid and relays can be contained in a small, rugged box affixed to a vehicle firewall, such as in a small rugged weatherproof container (under the hood). Because power has been disabled, the thief is required to break into the vehicle. In addition, the box is affixed under the dash on the firewall and contains the processor, transmitting/receiving circuitry and antennas, SIM carrier and SIM card.

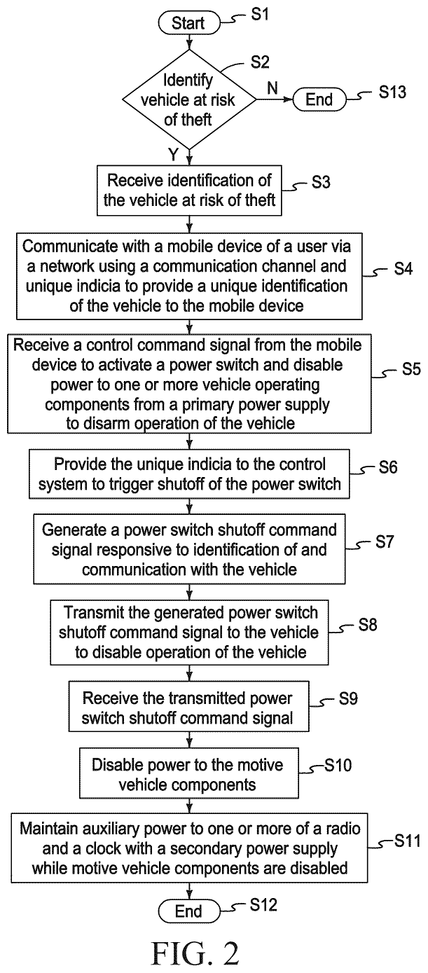

FIG. 2 is a flowchart of exemplary operational steps of the processor to disable power to motive components of a vehicle (as shown in FIG. 1). More particularly, a vehicle power security apparatus and method using the architecture of FIG. 1 initials a START sequence on a processor as Step “S1”. Following initiation of the process at Step “S1”, the process proceeds to Step “S2”.

In Step “S2”, the control system implements a query to “Identify vehicle at risk of theft”. If there is no detected vehicle at risk, the process ends at Step “S13”. If there is a detected risk, the process proceeds to Step “S3”.

In Step “S3”, the control system initiates “Receive identification of a vehicle at risk of theft”. After Step “S3”, the process then proceeds to Step “S4”.

In Step “S4”, the control system initiates “Communicate with a mobile device of a user via a network using a communication channel and unique indicia to provide a unique identification of the vehicle to the mobile device”. After Step “S4”, the process then proceeds to Step “S5”.

In Step “S5”, the control system initiates “Receive a control command signal from the mobile device to activate a power switch and disable power to one or more vehicle operating components from a primary power supply to disarm operation of the vehicle”. After Step “S5”, the process then proceeds to Step “S6”.

In Step “S6”, the control system initiates “Provide the unique indicia to the control system to trigger shutoff of the power switch”. After Step “S6”, the process then proceeds to Step “S7”.

In Step “S7”, the control system initiates “Generate a power switch shutoff command signal responsive to identification of and communication with the vehicle”. After Step “S7”, the process then proceeds to Step “S8”.

In Step “S8”, the control system initiates “Transmit the generated power switch shutoff command signal to the vehicle to disable operation of the vehicle. After Step “S8”, the process then proceeds to Step “S9”.

In Step “S9”, the control system initiates “Receive the transmitted power switch shutoff command signal”. After Step “S9”, the process then proceeds to Step “S10”.

In Step “S10”, the control system initiates “Disable power to the motive vehicle components”. After Step “S10”, the process then proceeds to Step “S11”.

In Step “S11”, the control system initiates “Maintain auxiliary power to one or more of a radio and a clock with the secondary power supply, along with the security system components, while motive vehicle components are disabled”. After Step “S11”, the process then proceeds to Step “S12”.

In Step “S12, the process is terminated, or ended.

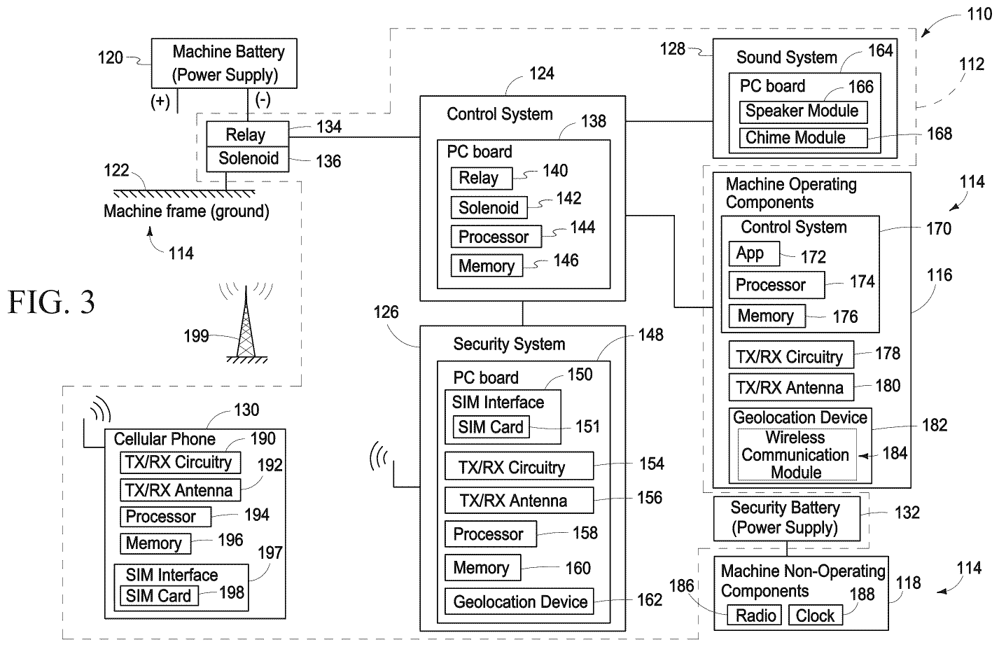

FIG. 3 graphically illustrates a block diagram of a machine power security device, or apparatus 112 that can be implemented on a machine 110 according to another exemplary embodiment of the present disclosure. Machine 110 can be a machine having an ability to be moved under power, or a machine that is moved using another device or vehicle or individual(s) to move the machine. For example, portable work electricity generators, laser screeds, construction machines, front end loaders, forklifts, welders, and lockable storage bins for construction site use can have machine operating components that are disabled using the machine power security system of this design. More particularly, a machine 110, such as a front end loader, having machine operating components 114 is shown having operating, or mobile components 116, non-operating machine components 118, a machine battery, or power supply 120, a machine frame, or ground 122, and a machine power security apparatus 112.

As shown in FIG. 3, machine operating components 116 include components that contribute to operation of the machine as a mobile device, such as powertrain, steering, computer operation and control, wheels and suspension, electrical system components contributing to motive operation of the machine, such as, a control system 70, transmitting and receiving circuitry 78, a transmitting and receiving antenna 80, and a geolocation device 82. Control system 70 includes a control system computer application, a processor, or processing circuitry 74, and memory 76. Geolocation device 82 comprises a wireless communication module 84. Module 84 can comprise one or more of a Global System for Mobile Communications (GSM), a Global Positioning System (GPS), or a satellite system, such as Russian GLONASS, European Galileo, Japanese QZSS and Chinese BeiDou Navigation Satellite System. One suitable commercially available open-source PC board system is a PC board for Arduino sold on Amazon.com as a SIM900 Quad-Band GPRS/GSM Shield Development Board for Arduino.

Additionally, FIG. 3 shows machine non-operating components 118 comprising a radio 186 and a clock 188. Clock 186 can be resident on radio 186 in some cases. Radio 186 can be provided in the form of a machine entertainment system that includes an internal clock and has memory for storing user data, such as device identification, time and calendar functions used by the entertainment system and/or machine.

Machine power security apparatus 112 of FIG. 3 comprises a control system 124, a security system 126, a sound system 128, a security battery 132, a power switch 133, and a cellular telephone 130. Control system 124 comprises a PC board 138 having a relay 140, a solenoid 142, a processor, or processing circuitry 144 and memory 146.

Security system 126 of machine power security apparatus 112 of FIG. 3 comprises a PC board 148 having a SIM interface 150 configured to removably receive a SIM card 152, transmitting/receiving circuitry 154, transmitting/receiving antenna 156, a processor, or processing circuitry 158, memory 160 and a geolocation device 162.

Sound system 128 of machine power security apparatus 112 of FIG. 3 comprises a PC board 164 having a speaker module 166 and a chime, or sound module 168.

Cellular telephone 130 of machine power security apparatus 112 of FIG. 3 comprises transmitting/receiving circuitry 190, transmitting/receiving antenna 192, processor, or processing circuitry 194, memory 196, a SIM interface 197, and a SIM card 198.

Power switch 133 of FIG. 3 comprises a relay 134 and a solenoid 136. In operation, relay 134 is signal activated from control system 124 to open and close another circuit that opens and closed solenoid 136. However, it is understood that any other kind of mechanical, electrical, electromechanical or electromagnetic switch can be used capable of opening and closing a ground (or optionally, a positive) lead to battery 120.

In operation, cellular phone 30 of FIG. 3 is configured to communicate via a cellular network over one or more antennas 199 with machine power security apparatus 112 to receive unique indicia, or identification of a machine and location, and send a power switch shutoff command to apparatus 112 to disable power to motive machine components 116 of vehicle components 114 of a machine 110 that has been stolen or is at risk of being stolen.

Machine battery, or first power supply 120 of FIG. 3 is a starter battery for a machine, such as a mobile forklift, or a diesel generator. Security battery, or second power supply 132 is a rechargeable battery that is trickled charged by machine battery 120 (trickle charger not shown) during normal vehicle operation and while parked/off. Security battery 132 is configured to only allow current to flow through a trickle charger at a reduced, or low current rating sufficient to charge security battery 132, but insufficient to operate motive components of the machine 110, such as a starter switch, starter motor, etc. In this way, second power supply 132 is isolated from first power supply 120. Optionally, an after-market DC power supply can be connected before power switch 133.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

I/We claim:

1. A vehicle power security apparatus, comprising:
a power switch configured to shut off one or more motive operating components of a vehicle from a power supply;
a control system having a processor communicating with the power switch and configured to:
receive identification of a vehicle at risk of theft;
generate a power switch shutoff command signal responsive to identification of and communication with the vehicle; and
transmit the generated power switch shutoff command signal to the vehicle to disable operation of the vehicle; and
a security system having a mobile communication device with a unique indicia to identify the vehicle, the security system provided in a concealed location to a third party user, signal coupled with the control system, and configured to:
communicate with a mobile device of a user (trusted person) via a network using a communication channel and unique indicia to provide a unique identification of the vehicle to the mobile device;
receive a control command signal from the mobile device to activate the power switch and disable power to one or more motive vehicle components to disarm operation of the vehicle; and
provide the unique indicia to the control system to trigger shutoff of the power switch.

2. The vehicle power security apparatus of claim 1, further comprising a first power supply configured to provide power to motive operating components of a vehicle and a second power supply independent of the first power supply isolated from providing power to motive operating components of the vehicle and configured to:
enable power to one of a non-motive vehicle component when power from the first power supply is disabled.

3. The vehicle power security apparatus of claim 2, wherein the non-motive vehicle component is one of a vehicle radio and a system clock.

4. The vehicle power security apparatus of claim 2, wherein the power switch comprises a solenoid provided between the first power supply on a circuit from the first power supply to the vehicle components.

5. The vehicle power security apparatus of claim 4, wherein the power switch further comprises a relay configured to open and close the solenoid responsive to an electrical signal from the control system.

6. The vehicle power security apparatus of claim 5, wherein the first power supply is a vehicle battery and the solenoid is provide on a ground wire between the vehicle battery and a vehicle ground configured to open and close an electrical circuit between the vehicle battery and the vehicle ground.

7. The vehicle power security apparatus of claim 5, wherein the relay is a first relay and the control system further comprises a second relay configured in signal communication with the first relay operative to transmit a signal comprising the remote switch shutoff command to activate the solenoid to shut off power and disable operation of the vehicle.

8. The vehicle power security apparatus of claim 5, wherein the first power supply is a vehicle battery and the second power supply is a rechargeable battery, trickle-charged by the vehicle battery and electrical system during normal operation, configured to enable current to flow from the rechargeable battery at a current rate insufficient to operate motive operating components of the vehicle, but sufficient to maintain operation of the one of the vehicle radio and the system clock from the rechargeable battery.

9. The vehicle power security apparatus of claim 5, further comprising switching circuitry configured between the rechargeable battery and motive operating components of the vehicle to enable, responsive to a power supply command signal, operation of the motive operating components of the vehicle sufficient to start and operate the vehicle.

10. The vehicle power security apparatus of claim 5, wherein the security system further comprises a geolocation device configured to communicate wirelessly with the vehicle to ascertain location of the vehicle.

11. The vehicle power security apparatus of claim 10, wherein the geolocation device comprises a wireless communication module.

12. The vehicle power security apparatus of claim 11, wherein the wireless communication module of the security system comprises a SIM (Subscriber Identifier Module) card and a SIM interface corresponding and communicating wirelessly with a counterpart SIM card and SIM interface provided on the vehicle.

13. The vehicle power security apparatus of claim 11, wherein the unique indicia identifying the vehicle is a SIM card number.

14. The vehicle power security apparatus of claim 12, wherein the mobile communication device further comprises transmitting and receiving circuitry and a transmitting and receiving antenna configured to communicate with a corresponding transmitting and receiving circuitry and a transmitting and receiving antenna on the vehicle.

15. The vehicle power security apparatus of claim 11, wherein the control system is encased in a container in an inconspicuous location under a vehicle hood.

16. A method of remotely securing a vehicle against theft, comprising:
providing a power switch and a control system with a processor, and a vehicle security system having a mobile communication device with a unique indicia to identify the vehicle, the security system provided in a concealed location to a third party user, signal coupled with the control system;
determining an identified vehicle having a risk of theft;
generating a power switch shutoff command signal responsive to identification of and communication with the vehicle;
transmitting the generated power switch shutoff command signal to the vehicle to disable operation of the vehicle;
communicating with a mobile device of a user (trusted person) via a network using a communication channel and unique indicia to provide a unique identification of the vehicle to the mobile device;
receiving a control command signal from the mobile device to activate the power switch and disable power to one or more motive vehicle components to disarm operation of the vehicle; and
providing the unique indicia to the control system to trigger shutoff of the power switch.

17. The method of claim 16, wherein providing the unique indicia comprises transmitting SIM card unique indicia from a user via a mobile cellular device to the vehicle security system on the vehicle.

18. The method of claim 16, further providing a primary power supply for motive vehicle components and a secondary power supply, and shutting off power from the primary power supply to the motive vehicle components responsive to providing the unique indicia.

19. The method of claim 16, further comprising, before shutting off power with the power switch from the primary power supply, maintaining power for one or more of a clock, a radio and the security system.

20. The method of claim 16, further maintaining power for the transmitting and receiving circuitry and the transmitting and receiving antenna of the vehicle of the security system.
